(19) United States
(12) Patent Application Publication
(10) Pub. No.: US 2002/0142073 A1
(43) Pub. Date: Oct. 3, 2002

(54) Paint set confectionery

(76) Inventor: Brad Baker, Colorado Springs, CO (US)

Correspondence Address: PEACOCK MYERS AND ADAMS P C, P O BOX 26927, ALBUQUERQUE, NM, 871256927

(21) Appl. No.: 10/040,576

(22) Filed: Dec. 28, 2001

Related U.S. Application Data
(63) Continuation-in-part of application No. 09/607,313, filed on Jun. 28, 2000.
Application No. 09/607,313 is a continuation of application No. PCT/US99/28550, filed on Dec. 2, 1999.
(60) Provisional application No. 60/110,675, filed on Dec. 2, 1998.

(51) Int. Cl. A23G 1/00

(52) U.S. Cl. 426/104

(57) ABSTRACT

A confectionery set comprising a coatable utensil, a container, and a flowable confectionery that cooperatively provide play value.

### CROSS-REFERENCE TO RELATED APPLICATIONS

This application is a continuation-in-part application of U.S. patent application Ser. No. 607,313, entitled “Paint Set Confectionery”, to Brad Baker, filed on Jun. 28, 2000, and the specification thereof is incorporated herein by reference.

### COPYRIGHTED MATERIAL

A portion of the disclosure of this patent document contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field)

The present invention relates to confectionery products.

2. Background Art

The confectionery industry uses a variety of tools or utensils to facilitate extraction of a candy material from a reservoir. For instance, the following design patents disclose candy dipping tools: U.S. Patent No. Des. 264,298, entitled “Candy Dipping Tool,” to Guttman, issued May 11, 1982, discloses a candy dipping tool with an elongated handle and a loop end; U.S. Patent No. Des. 264,169, entitled “Candy Dipping Tool,” to Guttman, issued May 4, 1982, discloses a candy dipping tool having an elongated handle and a forked end comprising two prongs; and U.S. Patent No. Des. 264,038, entitled “Candy Dipping Tool,” to Guttman, issued Apr. 27, 1982, discloses a candy dipping tool having an elongated handle and a spiral end for candy dipping. Another patent, U.S. Pat. No. 2,281,267, entitled “Eating Utensil,” to Chapman, issued Apr. 28, 1942, discloses eating utensils wherein the food-holding portion of the eating utensil contains a layer of edible flavored material.

The dipping of a foodstuff directly into another foodstuff is relatively common practice in food manufacturing, food service, and amongst consumers in general. The following patents disclose matter germane to these practices:

U.S. Pat. No. 5,676,990, entitled “Method of Food Article Dipping and Whipping in a Condiment Container,” to Wawrzynski, issued Oct. 14, 1997, discloses a method for removing excess condiment from a food article. The method has three steps: manipulating, inserting and removing. In the first step, manipulating, a slit is formed in a container containing the condiment. In the next step, inserting, the food article is inserted through the slit into the condiment container. The final step entails removing the food article from the container. As the food article is removed from the container, excess condiment is stripped off the food article as it passes through the slit.

U.S. Pat. No. 3,312,555, entitled “Handle-Anchored Formed Sugar Block and Method of Producing Same,” to Rossi et al., issued Apr. 4, 1967, discloses a handle-anchored formed sugar block for stirring a beverage in a container. The purpose of the apparatus is to sugar-sweeten beverages.

U.S. Pat. No. 1,718,997 entitled “Frozen Confection,” to Burt, issued Jul. 2, 1929, discloses a frozen confection substantially in the shape of a rectangular block attached to a stick handle. The confection may contain an edible shell composed of any suitable material such as chocolate, which will provide a relatively hard outer surface at normal temperatures. When chocolate is used, the frozen body portion is preferably dipped in the heated chocolate in substantially the same way that other candies and confections are dipped.

U.S. Pat. No. 5,370,884, entitled “Combination Sucker and Edible Powder,” to Coleman, issued Dec. 6, 1994, discloses a confectionery apparatus having a top plastic cap for housing a hard candy sucker and a lower plastic container for housing a powder or granular candy. After removing the top cap, the hard candy is moistened and then dipped into the powder or granular candy.

U.S. Pat. No. 3,840,678, entitled “Edible Spooning Device,” to Price, issued Oct. 8, 1974, discloses an edible product having food receiving cavities for spooning and consuming foodstuff.

Confectioneries having a shape of a non-edible are disclosed in the following patents: U.S. Patent No. Des. 269,559, entitled “Confection on a Stick,” to Sellares, issued Jul. 5, 1983, discloses a confection on a stick shaped in the form a fist with an extended index finger; U.S. Patent No. Des. 260,045, entitled “Frozen Confection or Similar Article,” to Frankel et al., issued Aug. 4, 1981, discloses a frozen confection or similar article that is in the shape of a foot; U.S. Patent No. Des. 177,206, entitled “Confection,” to Babcock, issued Mar. 27, 1956, discloses a tube piece confection shaped substantially like a spoon wherein the spoon end portion comprises a confection; U.S. Patent No. Des. 92,473, entitled “Lollipop or Similar Article,” to Keller, issued Jun. 12, 1934, discloses a lollipop or similar article in the shape of a mug with over-flowing froth; U.S. Patent No. Des. 62,611, entitled “Hard Candy Confection,” to Hochstraser, issued Jul. 3, 1923, discloses a hard candy confection having the shape of a face; and U.S. Pat. No. 16,030, entitled “Candy or Confection,” to Schwarzschild and Greenfield, issued Apr. 7, 1885, discloses a candy or confectionery in the shape of a broom wherein both the whisk and handle portion comprise the confectionery.

Food products, comprising multiple foodstuffs, having at least one discrete compartment that allows for or facilitates mixing are disclosed in the following patents:

U.S. Pat. No. 3,413,128, entitled “Bottle,” to Steinbarth et al., issued Nov. 26, 1968, discloses a bottle having two container portions. One container is designed to hold a liquid, such as an alcoholic beverage, while the other container is designed to hold a granular solid, such as salt.

U.S. Pat. No. 1,889,882, entitled “Container for Food Products,” to Woods, issued Dec. 6, 1932, discloses a container for food products that has at least two sections. The sections hold different food products and can be opened to allow co-mingling of the different food products.

U.S. Pat. No. 1,983,685, entitled “Receptacle for Food Products,” to Townsley, issued Dec. 11, 1934, discloses a receptacle for holding food products having a main bag portion and an auxiliary compartment. The auxiliary compartment is designed to contain a dry flavoring material. The auxiliary compartment may be opened such that the material contained within that compartment mixes with the material in the main bag portion.

U.S. Pat. No. 2,647,681, entitled “Seasoning Dispenser,” to Paoli, issued Aug. 4, 1953, discloses a package for bulk food such as potatoes or popcorn having a separate compartment for seasoning.

U.S. Pat. No. 2,824,010, entitled “Flavor-Containing Milk Container Top,” to Pedersen, issued Feb. 18, 1958, discloses a flavor-containing milk container top that affixes to a glass milk bottle, plastic milk bottle, or a carton milk container. The flavoring ingredients are released from the receptacle in the milk container top such that they mix with the milk.

Non-food products, having multiple components, having at least one discrete compartment that allows for or facilitates mixing are disclosed in the following patents:

U.S. Pat. No. 2,832,981, entitled “Device for Applying Liquid Adhesive or the Like,” to Breuhan, issued May 6, 1958, discloses a flexible-bodied container for liquid adhesive paint. The device also has a brush that can be in either an inverted or extended position. In the extended position, liquid from the container flows through the bristles of the brush for application. In the inverted position, the brush is in contact with the liquid in the container or the gaseous environment created by the liquid in the container such that the bristles do not harden.

A product marketed by B.L.P. Holland B.V. under the trademark PAINT POP and originally by TOPPS is a candy fabricated to resemble a paint roller and paint tray with the candy powder packaged in a separate envelope. The customer empties the candy into the paint tray and consumes the candy by rolling the paint roller on the tongue and in the tray. It does not have a lid for containing the powder.

U.S. Pat. No. 3,386,792, entitled “Paint Kit,” to Ireland, issued Jun. 4, 1968, discloses a device with a paintbrush and an integral container for paint. The paint container is housed in the end one end of the device while the paintbrush is positioned at the other end.

None of these patents disclose a confectionery, comprising multiple confectionery components, having at least one discrete compartment that allows for or facilitates mixing thereof wherein an edible component has the shape of a traditional non-edible.

### SUMMARY OF THE INVENTION (DISCLOSURE OF THE INVENTION)

The present invention comprises a confectionery set comprising: a coatable utensil; a container; and a flowable confectionery wherein the flowable confectionery is containable within the container and extractable by the coatable utensil. In a preferred embodiment of the present invention, the coatable utensil comprises a coatable portion and a handle portion where these portions comprise edible and/or non-edible material. Non-edible material comprises materials such as, but not limited to, wood, plastic and metal. Edible material comprises, for example, but not limited to, materials such as artificial sweetener, sugar, corn syrup, water, flavor agent, color agent and the like. In a preferred embodiment, edible confectionery of the coatable utensil comprises from between approximately 50% and 75% by weight of sugar; from between approximately 20% and 40% by weight of corn syrup; from between approximately 2% and 5% by weight of water; from between approximately 0.1% and 2% by weight of flavor agent; and from between approximately 0% and 1% by weight of color agent.

Flowable confectionery of the present invention comprises sugar-based or artificial sweetener-based confectionery. Combinations of sugar and artificial sweetener confectioneries are also within the scope of the present invention. Sugar-based flowable confectioneries of the present invention comprise materials such as, but not limited to, the following: sugar, organic acid, flavor agent, color agent, and flow agent. In a preferred embodiment of the present invention, flowable confectionery comprises from between approximately 90% and 98% by weight of sugar; from between approximately 1% and 6% by weight of organic acid; from between approximately 1% and 5% by weight of flavor agent; from between approximately 0.1% and 2% by weight of color agent; and from between approximately 0.1% and 5% by weight of flow agent. Flow agent comprises, for example, but not limited to, powdered cellulose, magnesium stearate, stearic acid, paraffin and microcrystalline waxes, polyethylene waxes, mineral and other lubricating oils, talc, silicone dioxide, lactose, calcium citrate and combinations thereof.

In another preferred embodiment of the present invention, flowable confectionery comprises a luminiferous confectionery, a gas generating and/or gas releasing confectionery.

In yet another embodiment of the present invention, the coatable utensil comprises a brush assembly comprising a handle portion and a bristle portion wherein the bristle portion comprises, for example, but not limited to, a plurality of bristles, a mass comprising surface indicia creating a bristle-like appearance, rigid bristles, resilient bristles, confectionery bristles, plastic bristles, rubber bristles and combinations thereof. In variations of this embodiment, the bristles comprise luminiferous bristles. In a preferred embodiment of the brush assembly embodiment, the brush assembly comprises a ferrule positioned between the handle portion and the bristle portion and the bristle portion is optionally modified for detachable releasability. In all of the embodiments, means exist for attaching the coatable utensil to the container. Attachment is achieved through, for example, but not limited to, shrink-wrap, adhesive, at least one additional cooperative part, and the like.

In various embodiments of the present invention, the container comprises, for example, but not limited to, a substantially rectangular pouch; a sack-like pouch; a human shape; an alien shape; a coffin shape; a sarcophagus shape; a cauldron shape; a spacecraft or UFO shape; a basket shape; a can shape; and the like.

In various embodiments of the present invention, the coatable utensil comprises, for example, but not limited to, a circular shape; a paint brush shape; a mummy shape; a vampire shape; a broom shape; an alien shape; a snake shape; a magic wand shape; a star shape.

In various embodiments of the present invention, the flowable confectionery comprises shaped pieces comprising, for example, but not limited to, at least one mineral nugget shape; at least one jewel shape; at least one insect shape; at least one rodent shape, including bats; at least one vegetable shape; at least one fruit shape; and the like. In a preferred embodiment, the flowable confectionery comprises a fluid. Where the flowable comprises shaped pieces and fluid, these pieces are additionally mixable with the fluid. In a preferred embodiment of the present invention comprising a fluid flowable confectionery, the fluid comprises viscoelastic Theological properties.

In an alternative embodiment, the confectionery set comprises a paint brush comprising a non-edible handle portion and an edible bristle portion; a can comprising a container and a lid, the container comprising at least one divider and at least two compartments therein; and a flowable confectionery in the container extractable by the paint brush edible bristle portion. The multiple confectioneries within the compartments may be different colors, different flavors, and/or different types. The confectionery set preferably comprises two compartments wherein the divider intersects a center of the container and the two compartments are similar opposing shapes.

The can preferably further comprises indentations for aligning the can during manufacturing. These indentations are preferably disposed at a base of the can. The indentations provide for aligning the can during manufacturing for filling the multiple compartments with different confectioneries.

The confectionery is preferably added to the container during manufacturing of the confectionery set. The confectionery set preferably further comprises packaging for attaching the paint brush to the can.

In another alternative embodiment, which may be combined with the can embodiments described herein, in particular the multiple compartment embodiment, the confectionery set comprises a paint brush comprising a non-edible handle portion and a bristle portion comprising multiple edible parts; a can comprising a container and a lid; and a flowable confectionery in the container extractable by the paint brush edible bristle portion. The multiple edible parts of the bristle portion of the paint brush may comprise different colors, different flavors, different types of confectioneries and/or different translucenscies.

A primary object of the present invention is to provide a confectionery product having characteristics of a traditional non-edible and utilitarian product.

A primary advantage of the present invention is enhanced play value due to interactive features of the product.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a frontal view of a brush of the present invention;

FIG. 2 is a side view of a brush of the present invention;

FIG. 3 is a perspective view of a brush of the present invention;

FIG. 4 is a perspective view of a paint can and lid of the present invention;

FIG. 5 is a perspective view of a paint can lid of the present invention;

FIG. 6 is a frontal view of a brush of the present invention showing affixation of a candy portion;

FIG. 7 is a perspective view of a paint can of the present invention;

FIG. 8 is a perspective view of a paint can lid of the present invention;

FIG. 9 is a frontal view of a brush of the present invention showing bristles;

FIG. 10a is a cross-sectional view of a paint can and lid of the present invention;

FIG. 10b is a top view of a paint can and lid of the present invention;

FIG. 10c is a segment of a cross-sectional view of a paint can and lid of the present invention;

FIG. 11a is a frontal view of a brush ferrule of the present invention;

FIG. 11b is a cross-sectional view of a brush ferrule of the present invention;

FIG. 12a is a frontal view of a brush handle of the present invention;

FIG. 12b is a side view of a brush handle of the present invention;

FIG. 13 is a frontal view of a brush handle and detachable ferrule of the present invention;

FIG. 14a is a frontal view of a brush and paint can assembly of the present invention;

FIG. 14b is a side view of a brush and paint can assembly of the present invention;

FIG. 14c is a top view of a brush and paint can assembly piece of the present invention;

FIG. 15 is a perspective view of a mummy and sarcophagus embodiment of the present invention;

FIG. 16 is a perspective view of a skeleton and coffin embodiment of the present invention;

FIG. 17 is a perspective view of a vampire and hinged coffin embodiment of the present invention;

FIG. 18 is a perspective view of a broom and cauldron embodiment of the present invention;

FIG. 19 is a perspective view of an alien and spaceship embodiment of the present invention;

FIG. 20 is a perspective view of a snake and basket embodiment of the present invention;

FIG. 21 is a perspective view of a wand and magician embodiment of the present invention;

FIG. 22 is a perspective view of a pouch embodiment of the present invention;

FIG. 23 is a top view of an alternative paint can container with multiple compartments and lid of the present invention;

FIG. 24 is a side view of a brush of the present invention showing divided flavor sections; and

FIG. 25 is a perspective view of the FIG. 23 can with indentations for the manufacturing process.

### DESCRIPTION OF THE PREFERRED EMBODIMENTS BEST MODES FOR CARRYING OUT THE INVENTION

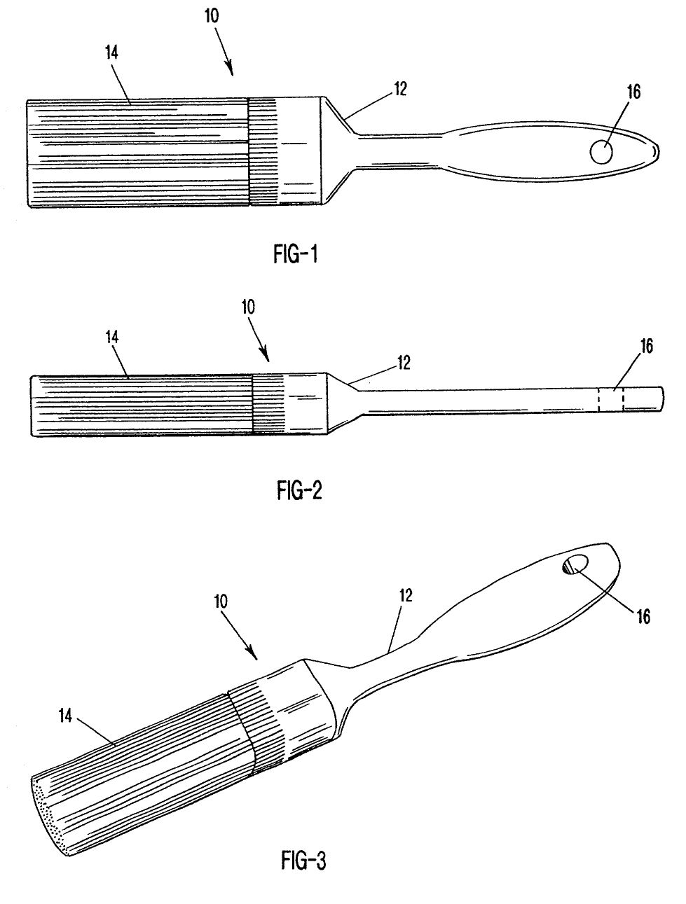

The present invention comprises a confectionery having enhanced play value. A preferred embodiment of the present invention comprises a brush and a can. A brush 10 of the present invention is shown in FIG. 1. As shown in FIG. 1, the brush 10 comprises a handle portion 12 and a bristle portion 14 The handle portion may comprise an aperture 16 for hanging, as shown in FIG. 1. The invention also comprises alternatives for hanging such as, but not limited to, a hook, adhesive, a magnet, and the like, either attached to a brush, a can, a lid, or packaging and/or packaging pieces of the present invention. FIG. 2 and FIG. 3 show alternative views of the brush of FIG. 1.

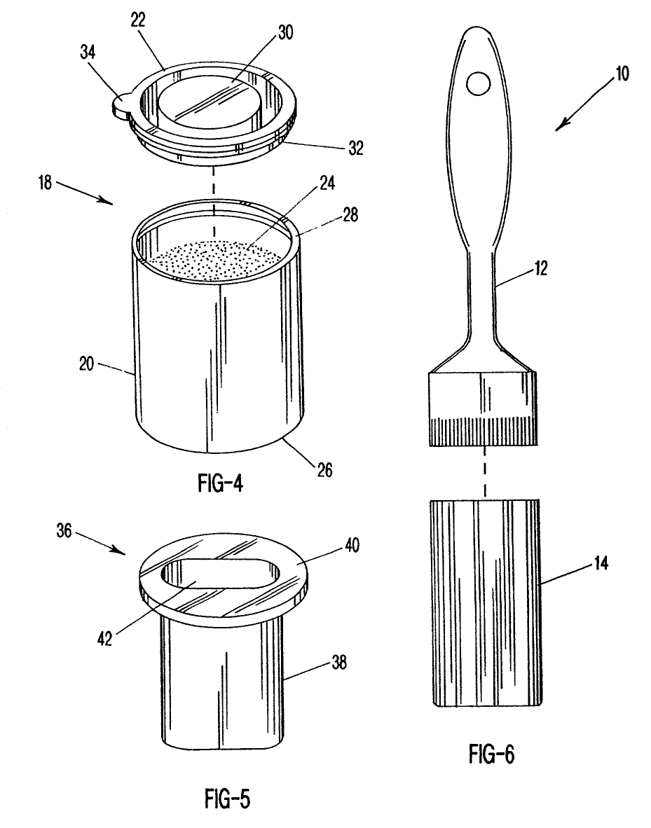

FIG. 4 shows an illustration of a can 18 of a preferred embodiment of the present invention. This can 18 further comprises a container 20, a lid 22 and contents 24. This preferred embodiment comprises a container 20 having a cylindrical shape with one open end 28 and one closed end 26.

The container 20 is capable of containing contents 24, such as a powder, fluid and/or other flowable confectionery. Lid 22 further comprises an upper surface 30, a lower surface 32 and a tab for assisting detachment 34. The lower surface 32 connects cooperatively with the open end 28 of the container 20 to seal contents 24 in the container 20. The tab 34 for assisting detachment, comprises, for example, but is not limited to, a pull tab or the like. When the lid 22 is cooperatively in contact with the container 20 to seal contents 24, detachment of the lid is facilitated by the tab 34.

FIG. 5 shows an alternative embodiment of a lid 36. This particular embodiment comprises an upper surface 40 and a lower surface 38 wherein the upper surface 40 defines a well 42. The well 42 illustrated in FIG. 5 is capable of receiving the bristle portion 14 of a brush 10 of the present invention.

FIG. 6 shows an illustration of a brush 10 of a preferred embodiment of the present invention wherein the bristle portion 14 is detachable from the handle portion 12. The detachable nature of the bristle portion 14 of the brush 10 allows for replacement and/or storage of the bristle portion 14. Replacement allows a user to replace a current bristle portion with a different bristle portion. The bristle portion 14 is replaceable with a bristle portion that comprises a confectionery or an alternative edible and/or non-edible portion that entertains a user. Additionally, with respect to a non-edible portion, a user is entertained by, but not limited to, a bristle portion comprising light emitting bristles or a light emitting bristle unit. Such bristle embodiments are described as luminiferous in that they give off or transmit light. The term luminiferous encompasses, but is not limited to, luminescence, fluorescence, and phosphorescence. For example, flexible bristle fibers capable of transmitting light from a source are within the scope of the present invention. A source is housable, for example, but not limited to, in the handle portion 12. Transmission of light from the source to flexible bristle fibers creates an optical effect that enhances play value of the present invention. In such an embodiment of the present invention, a source comprises, for example, but not limited to, a light bulb or a light emitting diode. Power for driving the source comprises, for example, but not limited to battery power, mechanical to electrical energy power, and/or solar to electrical energy power. FIG. 9 shows an illustration that more clearly depicts a bristle portion 14 that comprises individual bristles, typical of a generic paint brush, as opposed to a solid portion wherein bristles are agglomerated or a solid portion wherein surface indicia give an effect as to the presence of bristles. All of these variations are within the scope of the present invention.

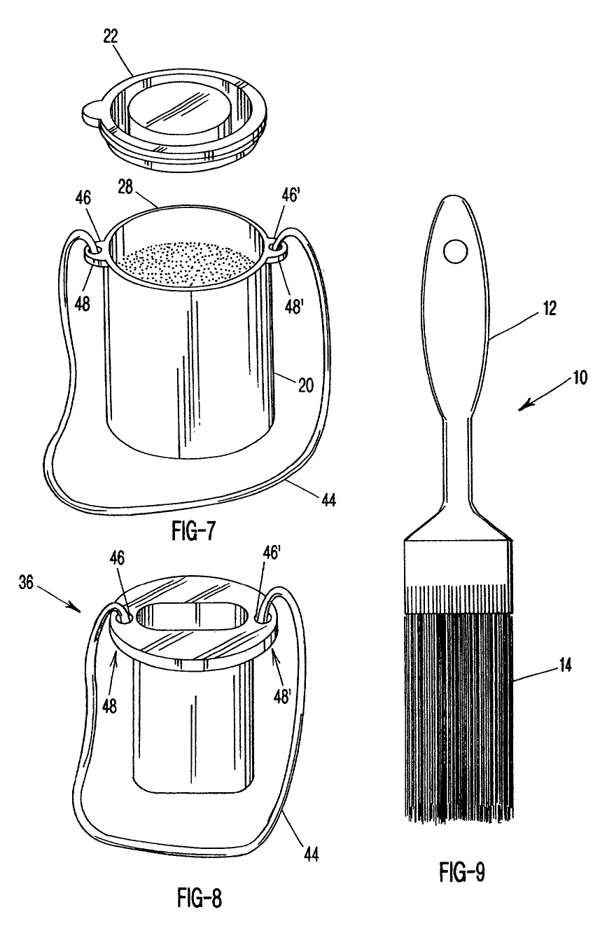

FIG. 7 shows an illustration of a preferred embodiment of a container 20 comprising a handle 44. In this particular embodiment, the handle 44 attaches to the container 20 at two points 46, 46′ adjacent to the open end 28 of the container. As shown in FIG. 7, handle 44 comprises a cord having two ends 48, 48′ that pass through apertures 46, 46′ adjacent to the open end 28 the container. These ends 48, 48′ are tied or otherwise fixed to prevent passage through the apertures 46, 46′. FIG. 8 shows a preferred embodiment of a lid 36 comprising a handle 44. This lid 36 is as described in FIG. 5 with the exception of the added handle 44. The lid 36 illustrated in FIG. 8 comprises a cord 44 having two ends 48, 48′ that pass through apertures 46, 46′ in the lid 36. These ends 48, 48′ are tied or otherwise fixed to prevent passage through the apertures 46, 46′.

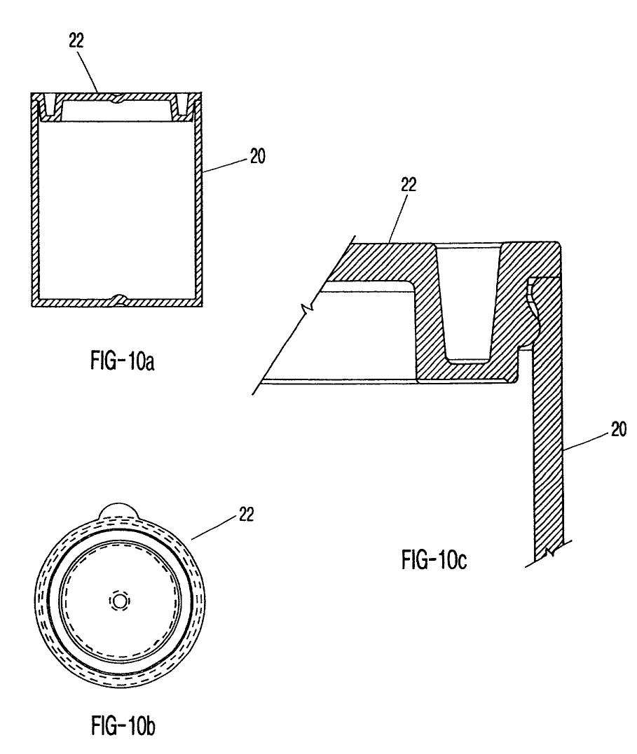

FIGS. 10a, 10b, and 10c show illustrations of a lid 22 of a preferred embodiment of the present invention cooperatively connected to a container 20. In this preferred embodiment, the lid 22 is press-fit connectedly onto the container 20.

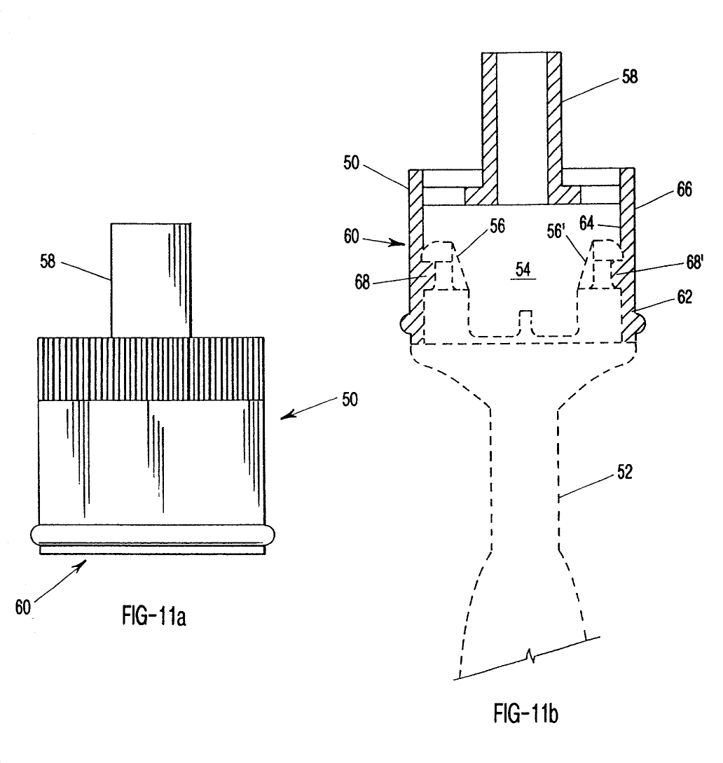

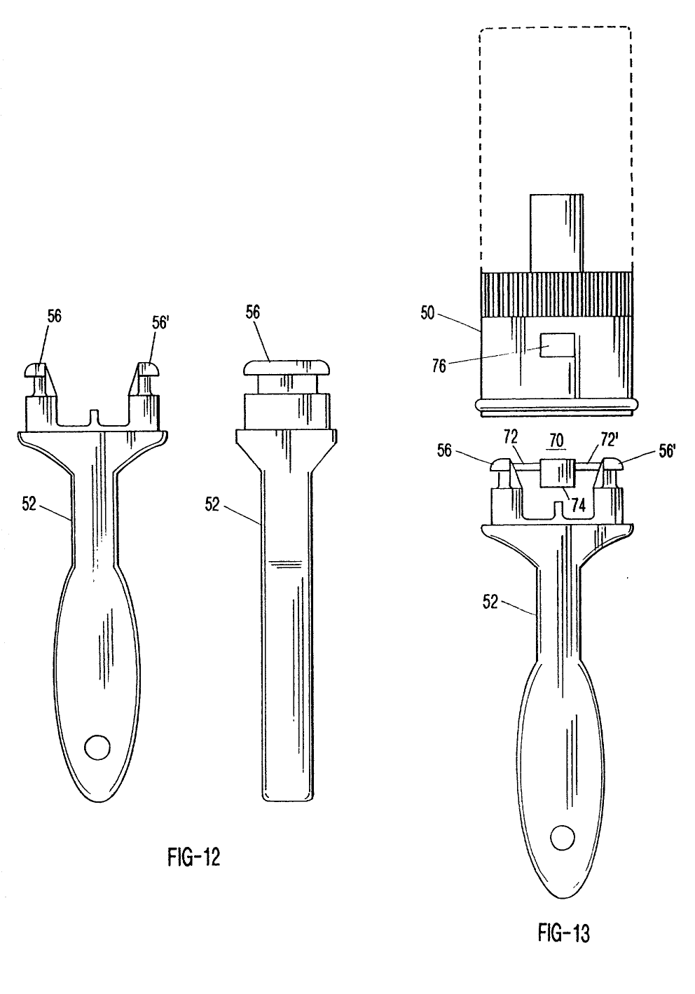

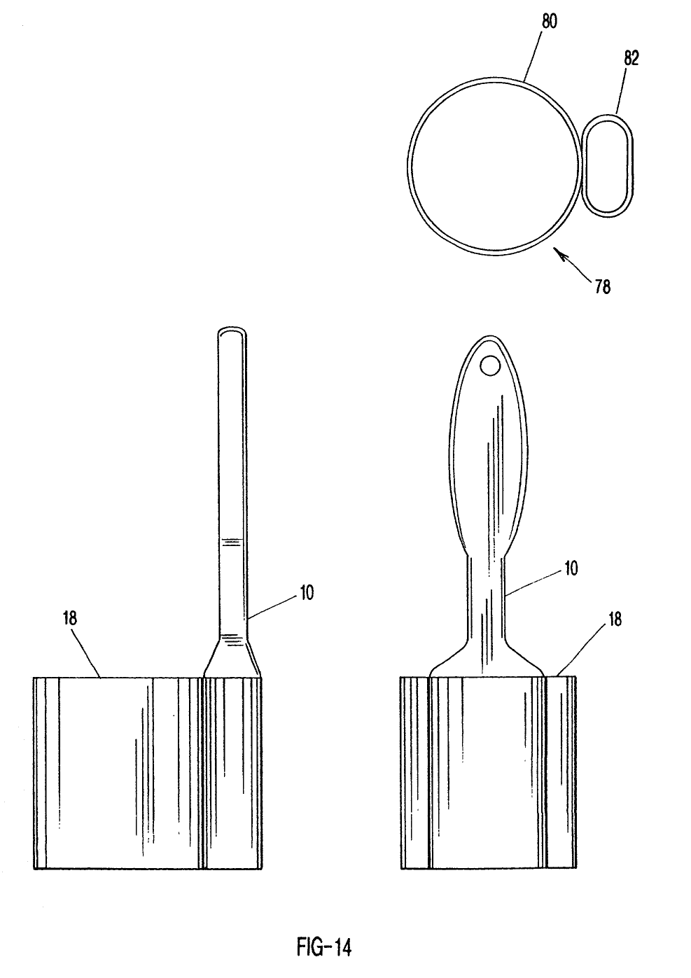

FIGS. 11a and 11b show illustrations of a ferrule 50 of a preferred embodiment of the present invention. The ferrule 50 comprises part of a handle 12 of a brush 10. In this particular embodiment, the ferrule 50 is connected to a handle stem 52 through a dual latch system 54. The dual latch system 54 comprises two latches 56, 56′ that cooperatively connect with the ferrule 50. As shown in FIGS. 11a and 11b, the ferrule 50 further comprises a bristle end 58 and a handle stem end 60. The handle stem end 60 of the ferrule 50 is defined by a substantially rectangular shaped wall 62 that together with the bristle end 58 defines a well. The substantially rectangular shaped wall 62 comprises an inner surface 64 and an outer surface 66. As illustrated in FIG. 11b, protrusions 68, 68′ from the inner surface 64 of the wall 62 cooperatively connect with latches 56, 56′ to fix the ferrule 50 to the handle stem 52. FIGS. 12a and 12b show a frontal view illustration and a side view illustration, respectively, of a handle stem 52 of a preferred embodiment of the present invention. FIG. 13 shows a frontal view illustration of a preferred embodiment of the present invention wherein the ferrule 50 is selectively detachable from the handle stem 52. In this embodiment, the handle stem 52 comprises a release mechanism 70 that further comprises a release button 74 and release bars 72, 72′. Application of pressure on the release button 74 causes release bars 72, 72′ to draw latches 56, 56′ inward. When the handle stem 52 shown in FIG. 13 is cooperatively connected to a ferrule 50 having a release button aperture 76, pressure on the release button 74 allows for selective attachment and detachment of the ferrule 50. The release mechanism illustrated in FIG. 13 is an example of but a single mechanism and is not meant to limit the present invention.

FIGS. 14a and 14b show illustrations of a brush 10 and a can 18. The brush 10 and can 18 are connectable through packaging 78 such as, but not limited to, shrink-wrap, adhesive or other packaging as shown in FIG. 14c, which comprises a finite length cylinder 80 connected to a finite length hollow tube section having a substantially rectangular cross section 82. The packaging 78, as shown in FIG. 14c, cooperatively receives can 18 and brush 10.

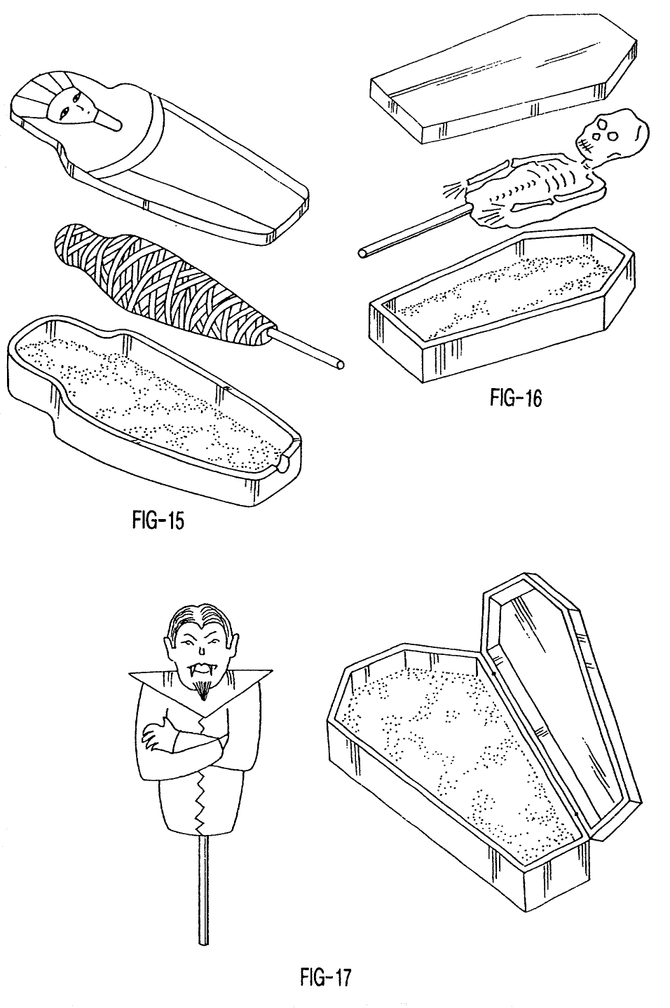

Additional embodiments of the present invention are shown in FIGS. 15 through 21. In the embodiments shown in FIGS. 15 through 21, a coatable utensil is provided which cooperates with a container for containing a flowable edible. In preferred embodiments, the coatable utensil comprises a coatable portion and a handle portion.

FIG. 15 is a perspective view of a mummy and sarcophagus embodiment of the present invention. In this embodiment, the mummy comprises, for example, an edible material, a non-edible material, and/or a luminiferous material. The mummy is also illuminable through use of an electric circuit and power supply. The sarcophagus of this embodiment comprises a container, comprising a sarcophagus body and a sarcophagus lid, for containing a flowable edible that is coatable on the mummy, i.e., the coatable utensil. The flowable comprises, for example, an edible that gives the impression of ooze, blood, gold, jewels, insects, rodents, dust and/or other material typically found in conjunction with Egyptian or other mummies. Furthermore, the flowable edible may further comprise a luminiferous material. The sarcophagus may also comprise a luminiferous material and/or be illuminable through use of an electric circuit and power supply.

FIG. 16 is a perspective view of a skeleton and coffin embodiment of the present invention. In this embodiment, the skeleton comprises, for example, an edible material, a non-edible material, and/or a luminiferous material. The skeleton is also illuminable through use of an electric circuit and power supply. The coffin of this embodiment comprises a container, comprising a coffin body and coffin lid, for containing a flowable edible that is coatable on the skeleton i.e., the coatable utensil. The flowable comprises, for example, an edible that gives the impression of ooze, blood, gold, jewels, insects, rodents, dust and/or other material typically found in conjunction with skeletons. Furthermore, the flowable edible may further comprise a luminiferous material. The coffin may also comprise a luminiferous material and/or be illuminable through use of an electric circuit and power supply.

FIG. 17 is a perspective view of a vampire and a hinged coffin embodiment of the present invention. In this embodiment, the vampire comprises, for example, an edible material, a non-edible material, and/or a luminiferous material. The vampire is also illuminable through use of an electric circuit and power supply. The coffin of this embodiment comprises a container, comprising a coffin body and a coffin lid, for containing a flowable edible that is coatable on the vampire i.e., the coatable utensil. The flowable comprises, for example, an edible that gives the impression of ooze, blood, gold, jewels, insects, rodents, dust and/or other material typically found in conjunction with vampires. Furthermore, the flowable edible may further comprise a luminiferous material. The coffin may also comprise a luminiferous material and/or be illuminable through use of an electric circuit and power supply.

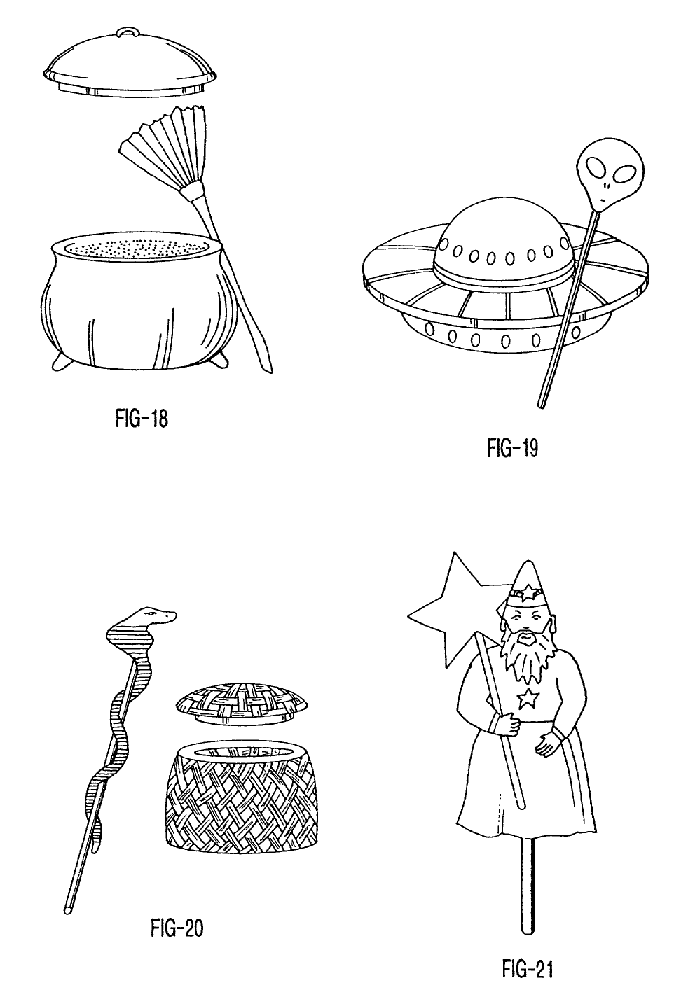

FIG. 18 is a perspective view of a broom and a cauldron embodiment of the present invention. In this embodiment, the broom comprises, for example, an edible material, a non-edible material, and/or a luminiferous material. The broom is also illuminable through use of an electric circuit and power supply. The cauldron of this embodiment comprises a container, comprising a cauldron body and a cauldron lid, for containing a flowable edible that is coatable on the broom i.e., the coatable utensil. The flowable comprises, for example, an edible that gives the impression of soup, stew, ooze, blood, gold, jewels, insects, rodents, dust and/or other material typically found in conjunction with witches. For example, a soup or stew can comprise edible pieces shaped as vegetables or fruits with or without an accompanying edible fluid. Furthermore, the flowable edible may further comprise a luminiferous material. The cauldron may also comprise a luminiferous material and/or be illuminable through use of an electric circuit and power supply.

FIG. 19 is a perspective view of an alien and a spaceship embodiment of the present invention. In this embodiment, the alien comprises, for example, an edible material, a non-edible material, and/or a luminiferous material. The alien is also illuminable through use of an electric circuit and power supply. The spaceship of this embodiment comprises a container, comprising a spaceship body and a spaceship lid, for containing a flowable edible that is coatable on the alien i.e., the coatable utensil. The flowable comprises, for example, an edible that gives the impression of ooze, blood, dust, jewels, radioactive material and/or other material typically found in conjunction with spaceships. Furthermore, the flowable edible may further comprise a luminiferous material. The spaceship may also comprise a luminiferous material and/or be illuminable through use of an electric circuit and power supply.

FIG. 20 is a perspective view of a snake and a basket embodiment of the present invention. In this embodiment, the snake comprises, for example, an edible material, a non-edible material, and/or a luminiferous material. The snake is also illuminable through use of an electric circuit and power supply. The basket of this embodiment comprises a container, comprising a basket body and a basket lid, for containing a flowable edible that is coatable on the snake i.e., the coatable utensil. The flowable comprises, for example, an edible that gives the impression of ooze, blood, gold, jewels, insects, rodents, dust and/or other material typically found in conjunction with places where snakes dwell or snake charmers. Furthermore, the flowable edible may further comprise a luminiferous material. The basket may also comprise a luminiferous material and/or be illuminable through use of an electric circuit and power supply.

FIG. 21 is a perspective view of a wand and magician embodiment of the present invention. In this embodiment, the wand comprises, for example, an edible material, a non-edible material, and/or a luminiferous material. The wand is also illuminable through use of an electric circuit and power supply. The magician of this embodiment comprises a container, comprising a magician lower body and a magician upper body that serves as a lid, for containing a flowable edible that is coatable on the wand i.e., the coatable utensil. The flowable comprises, for example, an edible that gives the impression of ooze, blood, gold, jewels, insects, rodents, dust and/or other material typically found in conjunction with magicians and wizards. Furthermore, the flowable edible may further comprise a luminiferous material. The magician may also comprise a luminiferous material and/or be illuminable through use of an electric circuit and power supply.

FIG. 22 is a perspective view of a pouch or “flow pack” embodiment of the present invention. In this embodiment, the pouch serves as a container for containing a flowable edible that is coatable on a utensil. The coatable utensil comprises edible and/or non-edible material. The pouch container comprises, for example, a foil pouch, a resealable pouch, a pouch comprising a draw-string, and the like. The shape of the pouch comprises rectangular, round, spherical, semi-spherical, and similar geometric shapes. Additionally, the pouch is formable as a human shape, alien shape or any of the aforementioned shapes described and shown in FIGS. 15-21. A preferred embodiment of the pouch comprises the ability to house at least one coatable utensil partially or completely within the pouch. Alternatively, at least one coatable utensil is housed in, for example, an additional pocket or side pouch, or attachable to an exterior surface of the pouch.

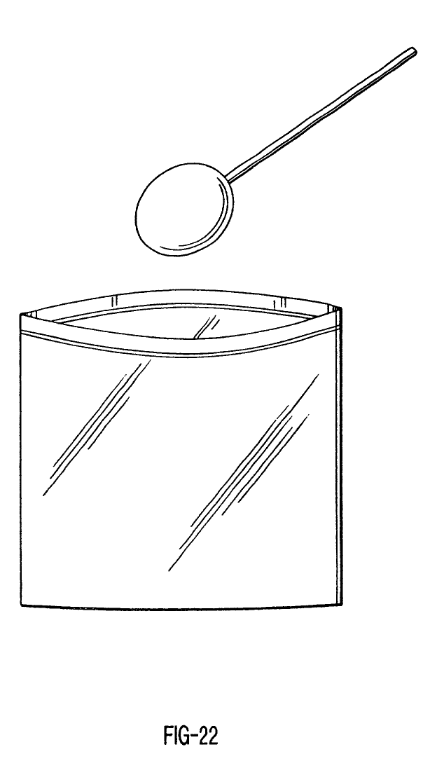

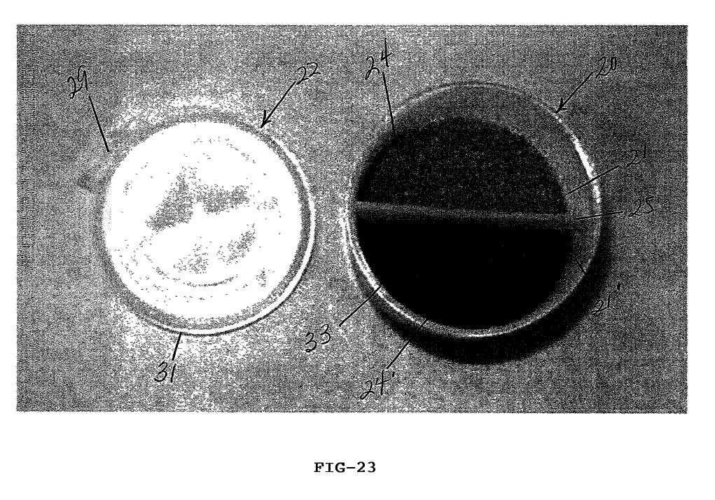

In an alternate embodiment, as depicted in FIG. 23, can comprises container 20 having multiple compartments 21, 21′ useful for containing different confections 24, 24′ (e.g., different flavors, colors, types (e.g. liquid and powder, popping and non-popping, etc.)). Multiple compartments 21 are preferably formed by use of at least one divider 25. Any number of dividers 25 may be employed to achieve the desired number of compartments 21, 21′. For instance, there may be two compartments as shown in the drawings, three compartments with a Y-shaped divider, etc. Brush 10 is insertable into the various compartments 21, 21′ depending on the confectionery desired by the user. In the preferred embodiment, there are two compartments 21, 21′ with a divider 25 that divides container 20 exactly in half. Brush 10 easily fits within each compartment 21, 21′, particularly when divider 25 is straight and intersecting container 20 to form compartments 21, 21′.

As shown in FIG. 23, lid 22 preferably snaps into and fits within container 20. Lid 22 comprises a finger flip 29 for ease of pulling off and opening lid 22 from container. Lid 22 is shaped so that protrusion 31 snap-fits into corresponding groove 33 within container 20. This snap-on fits provides for securing contents 24 within container 20.

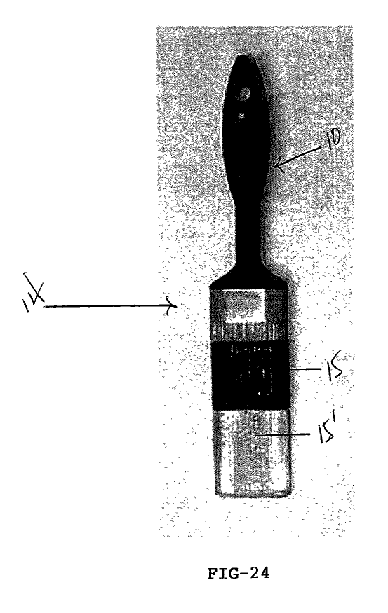

FIG. 24 shows an alternative embodiment wherein the confectionery of bristle portion 14 comprises multiple confectionery compositions, for example, multiple bristle layers 15, 15′. These different layers 15, 15′ may provide for different colors, different flavors, a hard candy layer and a chocolate layer, a translucent and non-translucent layer, or any other combination.

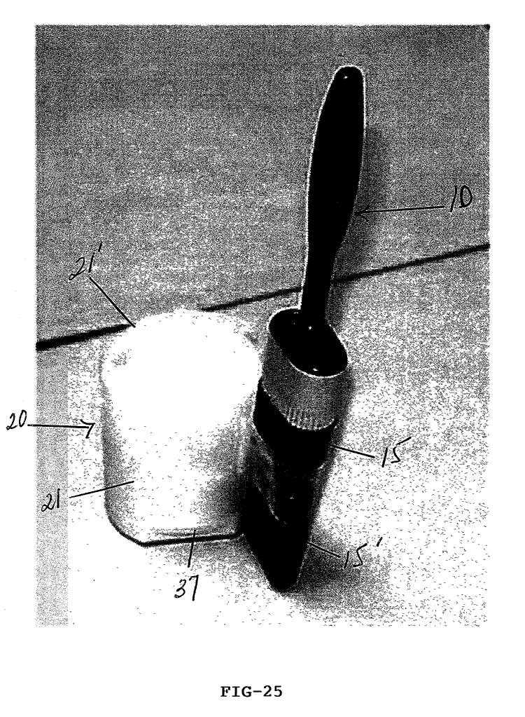

Can 20, as shown in FIG. 25, preferably has indentations 37, one on each side of its base. This is useful during the manufacturing process to line up compartments 21, 21′ for filling them with the different confectioneries. Packaging or attachments may be provided to attach paint brush to can.

In general, the present invention is broader than the various embodiments depicted in the illustrations. For example, in a preferred embodiment of the present invention, a confectionery brush comprises a resilient or rigid confectionery and a can contains a flowable confectionery wherein the resilient or rigid confectionery is coatable by the flowable confectionery. Also note, that throughout this disclosure, a confectionery is an edible.

In a preferred embodiment, the resilient or rigid confectionery is attachably removable from a handle. Alternatively, the resilient or rigid confectionery is consumable whereby another such confectionery attaches to the handle and thereby replaces the consumed confectionery. Of course, the confectionery characteristics of the replacement may differ from the characteristics of the original or prior confectionery. Confectionery characteristics include, but are not limited to, shape, hardness, flavor, color, translucency, gassification, effervescent (e.g., bicarbonate-based), edible inclusions, and the like. With respect to shape, bristle like characteristics are preferred thereby simulating the bristles of a brush, for example, a paintbrush bristles. In particular, resilient licorice bristles, or bristles comprising resilient candy, are within the scope of the present invention.

The flowable confectionery portion of the present invention comprises a flowable substance such as a liquid or a powder, or combination thereof. A container contains the flowable portion or portions. Containers with multiple compartments for containing flowable portions having same or different characteristics is also within the scope of the present invention. In a preferred embodiment, a single compartment container contains viscous liquid or powder confectionery. The single compartment container also has an opening and/or closing mechanism and/or apparatus for allowing access to the flowable confectionery, for example, but not limited to a lid. Preferably, a paint can-like container with a detachable lid is used to contain and seal and unseal the contents of the container. However, other container arrangements are encompassed by the present invention and include, but are not limited to, a tube with a flip or a screw cap and the like.

In a preferred embodiment configured as a paintbrush and paint can, or bucket, the non-edible portion of the paintbrush is manufactured through a process such as injection molding, vacuum molding, or the like. For instance, the non-edible portion of the brush is manufactured through injection molded plastic, or other suitable material, in at least one piece, preferably, two pieces, whereby a deposited candy portion is attached. The injection molded pieces cooperatively hold the candy portion and provide for a handle. In this preferred embodiment, one piece comprises a substantially handle shaped portion that snap-fits and locks into a second piece. The second piece is, for example, a ferrule with a tubular insert portion that inserts into the deposited candy portion. The candy is deposited into, for example, a book mold. The two-piece handle is inserted into the candy. The candy hardens over a period of time where the completed piece is subsequently de-molded.

The completed paintbrush pop is then packaged. The pop is inserted in a package such as a polypropylene bag. When a bag is used, it is sealed around the handle of the paintbrush or alternatively, around the entire product.

The paint can of this particular preferred embodiment is also manufactured, for instance, through an injection molding process, a vacuum form process or the like. An injection molded plastic, or other suitable material, is used to form a container for containing an edible powder or liquid. During manufacture, the container comprises at least one piece and, when more than one piece is used, the pieces are joined. A lid or other such suitably functioning piece is manufactured similarly. Labeling of the paint can shaped plastic container typically follows together with filling with a powdered or liquid candy. In this particular preferred embodiment, the removable lid is then snap-fit onto the paint can.

In this particular preferred embodiment, the packaged paintbrush pop is attached to the completed paint can using a heat shrink sleeve, or similar process, to become a single sell unit. However, the items, confectionery portions and non-edible portions, are saleable individually as well.

The single sell unit is packed onto a variety of point of purchase displays and cartoned.

Regarding the composition of confectioneries of the present invention, for example, a hard candy portion is manufactured from:

| | |
|---|---|
| Sugar | from approximately 55% to approximately 75% by weight |
| Corn Syrup | from approximately 20% to approximately 40% by weight |
| Water | from approximately 1% to approximately 5% by weight |
| Flavor Agent | from approximately 0.1% to approximately 2% by weight |
| Color Agent | from approximately less than 1% by weight |

Whereas a candy powder portion, for example, is manufactured from:

| | |
|---|---|
| Sugar | from approximately 90% to approximately 98% by weight |
| Malic Acid | from approximately 1% to approximately 6% by weight |
| Flavor Agent | from approximately 1% to approximately 5% by weight |
| Color Agent | from approximately 0.1% to approximately 2% by weight |
| Flow Agent | from approximately 0.1% to approximately 5% by weight |

The flow agent comprises a substance that promotes flowability of the candy powder of this example. Flow agents comprise, but are not limited to, for example, powdered cellulose, magnesium stearate, stearic acid, paraffin and microcrystalline waxes, polyethylene waxes, mineral and other lubricating oils, talc, silicone dioxide, lactose, calcium citrate and the like. In general, flow agents reduce attractive and/or frictional forces between particles and/or absorb moisture. In some instances, flow agents are known as anti-caking agents and/or desiccating agents. Examples of useful flow agents include CAB-O-SIL® (Cabot Corporation, Boston, Mass.) and SYLOID® (W.R. Grace & Co., New York, N.Y.).

The preceding example can be repeated with similar success by substituting the generically or specifically described reactants and/or operating conditions of this invention for those mentioned throughout this disclosure. For example, consider the alternative given below where a hard candy portion is manufactured from ingredients in the ranges:

| | |
|---|---|
| Sugar | from approximately 0% to approximately 95% by weight |
| Corn Syrup | from approximately 0% to approximately 80% by weight |
| Water | from approximately 0% to approximately 50% by weight |
| Flavor Agent | from approximately 0% to approximately 20% by weight |
| Color Agent | from approximately 0% to approximately 10% by weight |

Likewise, a candy powder portion is manufactured from ingredients in the ranges:

| | |
|---|---|
| Sugar | from approximately 0% to approximately 100% by weight |
| Malic Acid | from approximately 0% to approximately 40% by weight |
| Flavor Agent | from approximately 0% to approximately 20% by weight |
| Color Agent | from approximately 0% to approximately 10% by weight |
| Flow Agent | from approximately 0% to approximately 5% by weight |

Regarding non-edible portions of various embodiments of the present invention, manufacture is from materials such as, but not limited to, wood, plastic, metal and combinations thereof. For example, a paintbrush handle portion was formed through a molding process wherein one piece was manufactured from acrylonitrile-butadiene-styrene (“ABS”) and another piece was manufactured from polypropylene (“PP”). A paint can portion was formed through a molding process wherein a paint can container portion was manufactured from high-density polyethylene (“HDPE”) and a lid portion was manufactured from low-density polyethylene (“LDPE”).

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and such variation and modifications are covered in this disclosure to the extent that they are modifications and/or equivalents. The entire disclosures of all references, applications, patents, and publications cited above are hereby incorporated by reference.

What is claimed is:

1. A confectionery set comprising:
a paint brush comprising a non-edible handle portion and an edible bristle portion;
a can comprising a container and a lid, said container comprising at least one divider and at least two compartments therein; and
a flowable confectionery in said container extractable by said paint brush edible bristle portion.

2. The confectionery set of claim 1 comprising multiple confectioneries within said compartments.

3. The confectionery set of claim 2 wherein said multiple confectioneries comprise different colors.

4. The confectionery set of claim 2 wherein said multiple confectioneries comprise different flavors.

5. The confectionery set of claim 2 wherein said multiple confectioneries comprise different types.

6. The confectionery set of claim 1 wherein said paint brush comprises multiple edible portions.

7. The confectionery set of claim 6 wherein said multiple edible portions comprise different colors.

8. The confectionery set of claim 6 wherein said multiple edible portions comprise different flavors.

9. The confectionery set of claim 6 wherein said multiple edible portions comprise different types of confectioneries.

10. The confectionery set of claim 6 wherein said multiple edible portions comprises different translucenscies.

11. The confectionery set of claim 1 wherein said lid is cooperably engageable with said container, sealing said confectionery therein.

12. The confectionery set of claim 1 wherein said lid comprises a tab for ease in opening.

13. The confectionery set of claim 1 wherein said can further comprises indentations for aligning said can during manufacturing.

14. The confectionery set of claim 13 wherein said indentations are disposed at a base of said can.

15. The confectionery set of claim 13 wherein said indentations provide for aligning said can during manufacturing for filling said multiple compartments with different confectioneries.

16. The confectionery set of claim 1 wherein said confectionery is added to said container during manufacturing of said confectionery set.

17. The confectionery set of claim 1 further comprising packaging for attaching said paint brush to said can.

18. The confectionery set of claim 1 comprising two compartments wherein said divider intersects a center of said container and said two compartments are similar opposing shapes.

19. A confectionery set comprising:
a paint brush comprising a non-edible handle portion and a bristle portion comprising multiple edible parts;
a can comprising a container and a lid; and
a flowable confectionery in said container extractable by said paint brush edible bristle portion.

20. The confectionery set of claim 19 wherein said multiple edible parts of said bristle portion of said paint brush comprise different colors.

21. The confectionery set of claim 19 wherein said multiple edible parts of said bristle portion of said paint brush comprise different flavors.

22. The confectionery set of claim 19 wherein said multiple edible parts of said bristle portion of said paint brush comprise different types of confectioneries.

23. The confectionery set of claim 19 wherein said multiple edible parts of said bristle portion of said paint brush comprise different translucenscies.

24. The confectionery set of claim 19 wherein said lid is cooperably engageable with said container, sealing said confectionery therein.

25. The confectionery set of claim 19 wherein said lid comprises a tab for ease in opening.

26. The confectionery set of claim 19 further comprising packaging for attaching said paint brush to said can.
